(19) United States
(12) Patent Application Publication
(10) Pub. No.: US 2026/0051668 A1
(43) Pub. Date: Feb. 19, 2026

(54) ANTENNA

(71) Applicant: Chelton Limited, Marlow (GB)

(72) Inventors: Michael Philippakis, Marlow (GB); Peter Talbot, Marlow (GB); George Woodbridge, Marlow (GB)

(21) Appl. No.: 19/293,567

(22) Filed: Aug. 7, 2025

(30) Foreign Application Priority Data
Aug. 14, 2024 (GR) 20240100574
Aug. 21, 2024 (GB) 2412351.5

(51) Int. Cl. H01Q 21/06; H01Q 1/52

(52) U.S. Cl. CPC H01Q 21/065; H01Q 1/521

(57) ABSTRACT

A stacked patch array antenna (10) comprises a first substrate (12), a first array of patch radiators (16a) arranged on the first substrate (12), and a second array of patch radiators (16b). Each radiator (16b) of the second array is stacked with a respective radiator (16a) of the first array, so that each radiator (16a) of the first array is disposed between the first substrate (12) and a respective radiator (16b) of the second array.

### CROSS REFERENCE TO RELATED APPLICATIONS

This application claims benefit of priority Greece application No. 20240100574 filed 14 Aug. 2024 and Great Britain Application No. 2412351.5 filed 21 Aug. 2024 the contents of which are hereby incorporated by reference in its entirety for all purposes.

### TECHNICAL FIELD

This invention relates to the field of antennas. In particular, the invention relates to anti-jam GNSS antennas.

### BACKGROUND

Various satellite systems are in use for navigational purposes, including the global navigation satellite system (GNSS), which includes the global positioning system (GPS) and Galileo, among others, and also regional navigation satellite systems (RNSS). References in this specification to GNSS should be understood to refer also to RNSS unless the context demands otherwise.

Such satellites typically operate at multiple different frequencies, which for GPS includes 1575.42 MHz, which is often referred to as the ‘L1’ frequency, and 1227.60 MHz, which is commonly referred to as the ‘L2’ frequency. GNSS signals are also typically right-hand circularly polarized. Antennas used to transmit and receive GNSS signals are therefore often configured to operate in multiple bands, where each band contains one of the frequencies used in GNSS systems. For example, GNSS antennas may be configured for dual-band operation, corresponding to the L1 and L2 frequencies.

Some GNSS antennas are in the form of microstrip patch antennas, which typically include a flat sheet, or ‘patch’, of conductive material such as metal, which is mounted over a conductive ground plane, which is again typically of metal. The patch is separated from the ground plane by a substrate layer that extends between the two conductive layers. The substrate layer may be of a similar type to those used in printed circuit boards (PCBs), for example. A basic microstrip patch antenna element may comprise a substrate layer with a metallised upper surface defining the patch and a metallised lower surface defining the ground plane to form a patch antenna element. Conveniently, such elements may be fabricated using processes similar to those used for PCB manufacture.

Stacked patch antennas may be used to cover multiple frequency bands for use as a GNSS antenna, for example to cover both the L1 and the L2 frequencies for the case of a GPS antenna. Such antennas may include two substrate layers stacked one on top of the other and fixed to one another and to a ground plane, each substrate carrying a patch that is tuned to resonate at a respective frequency. In a dual-band GNSS antenna, generally the lower frequency patch requires a larger metallisation surface area, and so is situated underneath the higher frequency patch, which typically requires a smaller metallisation surface area. For the example of a GPS antenna, the lower frequency may correspond to GPS L2 and the higher frequency may correspond to GPS L1.

GNSS signals are typically relatively low power and are thus vulnerable to jamming signals, which can interfere with the true GNSS signals and therefore obstruct communication between an antenna and a satellite. To counteract this, anti-jam GNSS antennas may incorporate an array of antenna elements, and optionally an array of stacked elements, providing multiple received signals that can be processed to remove the interference and thereby maintain communication.

Configuring an anti-jam GNSS antenna may involve shaping its total angular response in a way that maintains an adequate response towards valid navigational signals while becoming substantially insensitive towards angular directions from which interference may emanate. In the case of GNSS antenna arrays, this may be achieved by placing the roots of the polynomial—the function that mathematically resembles its combined radiation pattern-such as the total antenna system response, to equivalent values representing interference directions. The effectiveness of this approach may depend on the positional accuracy of the radiators relative to one another within the array, and also on the extent to which the performance of each element possesses well-defined, stable, and adequately separated embedded array phase centres.

GNSS antennas are used in a range of applications, often with limited packaging space available and with a need to conform to, or otherwise minimise disruption to, existing exterior surfaces. It is therefore desirable for GNSS antennas to be compact, although reducing the size of an antenna typically impacts its performance. In certain applications, such as in supersonic flight, a GNSS antenna may also need to be capable of withstanding high temperatures. These constraints may need to be met whilst also allowing for accurate and reliable mass production of the antenna and adhering to relevant communications standards.

It is against this background that the present invention has been devised.

### SUMMARY OF THE INVENTION

According to an aspect of the present invention, there is provided a stacked patch array antenna, comprising: a first substrate; a first array of patch radiators arranged on the first substrate; and a second array of patch radiators. Each radiator of the second array is stacked with a respective radiator of the first array, so that each radiator of the first array is disposed between the first substrate and a respective radiator of the second array.

The first substrate defines a common substrate that is shared by the patch radiators of the first array. The first substrate may be unitary and/or formed as a single piece, for example. It is also possible to create the first substrate by joining separate pieces together. Arranging radiators on a common substrate enables precise positioning of the radiators relative to one another, which benefits performance, particularly for anti-jam applications. The use of a common substrate may also ease assembly compared to known arrangements based on separate stacked elements.

The radiators of the first array may be configured for a first frequency band. The first frequency band may correspond to a first GNSS frequency or RNSS frequency, which may optionally be a GPS frequency, so that the GNSS frequency or RNSS frequency falls within the first frequency band. The radiators of the second array may be configured for a second frequency band. The second frequency band may be higher than the first frequency band. The second frequency band may correspond to a second GNSS frequency or RNSS frequency, which may optionally be a GPS frequency, so that the GNSS frequency or RNSS frequency falls within the second frequency band. Each of the first and second frequency bands may define a range of frequencies in which the radiators of the respective array are configured to transmit and receive signals, typically with a certain gain.

The antenna may comprise a first ground plane on an opposite side of the first substrate to the first array of radiators.

Each radiator of the second array may be formed on a respective second substrate to form a radiator element. The radiator elements may be mutually spaced. Each radiator element may comprise a respective second ground plane on an opposite side of the second substrate to the respective radiator. Each radiator element is optionally fused to a respective radiator of the first array.

Each radiator of the second array may cover a portion of the corresponding radiator of the first array, namely the radiator of the first array with which the radiator of the second array is stacked, and a remaining portion of the radiator of the first array may be exposed. Each radiator of the first array may therefore extend beyond the envelope of the associated radiator of the second array. This advantageously allows access to the radiators of the first array for tuning.

Each stacked pair of radiators of the first and second arrays may be centred on a common axis that is orthogonal to a surface of the first substrate. Respective edges of the radiators of a stacked pair may be aligned to extend in parallel.

The antenna may comprise a barrier extending between adjacent radiators of the first array. The barrier may also extend between adjacent radiators of the second array. In this respect, ‘adjacent’ radiators may be adjacent in a direction parallel to the surface of the first substrate on which the radiators of the first array are arranged. Adjacent radiators may therefore be side-by-side in a plane parallel to the surface of the first substrate on which the radiators of the first array are arranged. The barrier may be configured to resist interaction between adjacent radiators, such as mutual coupling, and so may act as a shield. The barrier may be mounted to, and optionally upstanding from, the first substrate, and may extend orthogonally to a surface of the first substrate on which the radiators of the first array are arranged. The barrier may be upright relative to the first substrate. The barrier may be electrically connected to the first ground plane. The antenna may have multiple barriers. The antenna may comprise a barrier extending between each adjacent pair of radiators of each of the first and second arrays. The antenna may comprise a pair of barriers that are orthogonal to one another, which barriers may intersect at a centre of the first substrate. The, or each, barrier may comprise a barrier member. The, or each, barrier optionally comprises a plate element. The barrier may have the form of a rib or a fin. The barrier may be relatively tall in a direction orthogonal to a surface of the first substrate on which the radiators of the first array are arranged and relatively thin in a plane parallel to that surface. The barrier may be straight and so may be generally planar. Alternatively, the barrier may have one or more bends and may be wavy or jagged, for example having a zig-zag or saw-tooth pattern in a plane parallel to a surface of the first substrate on which the radiators of the first array are arranged. The barrier may extend further from the first substrate than any of the radiators of the first and second arrays.

The antenna may comprise at least one electrical link extending through the first substrate. The, or each, electrical link may comprise a via, for example. The, or each, link optionally extends from a surface of the first substrate on which the radiators of the first array are arranged to an opposite side of the first substrate. The, or each, link may be disposed between adjacent radiators of the first array. At least one row of links may extend between adjacent radiators of the first array. The antenna may comprise a conductor arranged on the same side of the first substrate as the radiators, which conductor may connect links together electrically. The conductor may be defined by a trace, track or strip of conductive material, for example. The, or each, link may be electrically connected to the first ground plane.

The, or each, barrier may be electrically connected to at least one electrical link. The, or each, barrier may therefore be grounded to the first ground plane, through the link. At least one link may be located directly beneath a barrier.

The antenna may comprise a shielding arrangement configured to resist interaction between the radiators, for example radiative coupling between the radiators, and/or coupling between the radiators due to the effect of surface waves, for example surface waves forming on a surface of the first substrate and/or propagating through the first substrate. The shielding arrangement may comprise the barrier(s) and/or the electrical link(s) described above.

The first substrate may be of ceramic material.

The antenna may comprise a feed arrangement configured to feed the first and second arrays of radiators. The feed arrangement may be configured to feed the radiators of the second array directly. The radiators of the first array may be fed by capacitive coupling. The feed arrangement may comprise a stripline arrangement.

The radiators of the first array may comprise respective coplanar surfaces.

In some embodiments, the radiators of the first array extend in a first plane, and the radiators of the second array extend in a second plane that is parallel to the first plane. The first and second arrays may therefore be arranged in layers.

At least one, and optionally all, of the radiators may be substantially square. The radiators within each of the first and second arrays may be regularly spaced and may be arranged in a square pattern, for example.

The antenna may be configured as an anti-jam antenna.

The antenna may be configured for communication with a satellite system. For example, the antenna may be configured as a GNSS or RNSS antenna and optionally as a GPS antenna.

The radiators of the first array may be in direct contact with the first substrate. For example, the radiators may be defined by metallised areas formed on a surface of the first substrate, or in another example the radiators could be formed as plate elements that are attached to a surface of the first substrate.

The invention also extends to a communication system comprising the antenna of the above aspect. The communication system may form part of a navigation system.

The invention also extends to a navigation system comprising the antenna or the communication system of the above aspects.

Another aspect of the invention provides a method of producing a stacked patch array antenna. The method comprises: arranging a first array of patch radiators on a first substrate; and arranging a second array of patch radiators so that each radiator of the second array is stacked with a respective radiator of the first array, and each radiator of the first array is disposed between the first substrate and a respective radiator of the second array.

It will be appreciated that preferred and/or optional features of each aspect of the invention may be incorporated alone or in appropriate combination in the other aspects of the invention also.

### BRIEF DESCRIPTION OF THE DRAWINGS

One or more embodiments of the invention will now be described, by way of example only, with reference to the accompanying drawings, in which like features are assigned like numerals, and in which:

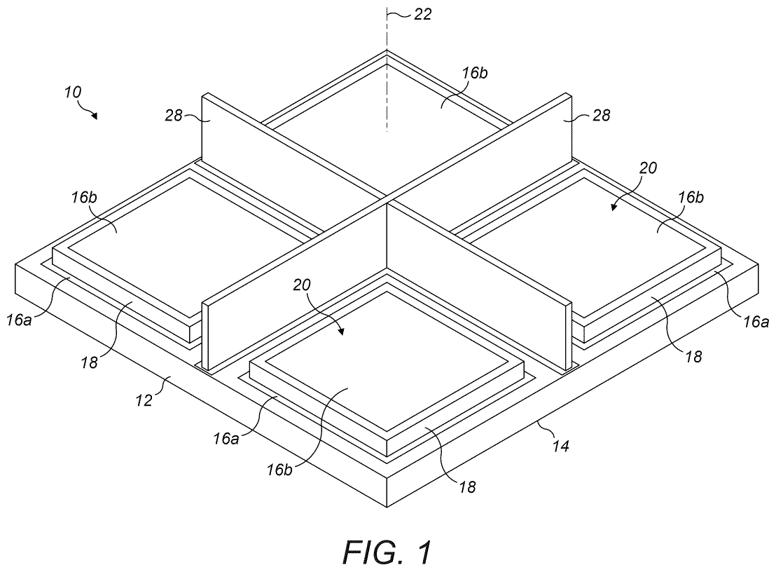

a. FIG. 1 shows a stacked patch array antenna according to an embodiment of the invention in isometric view;

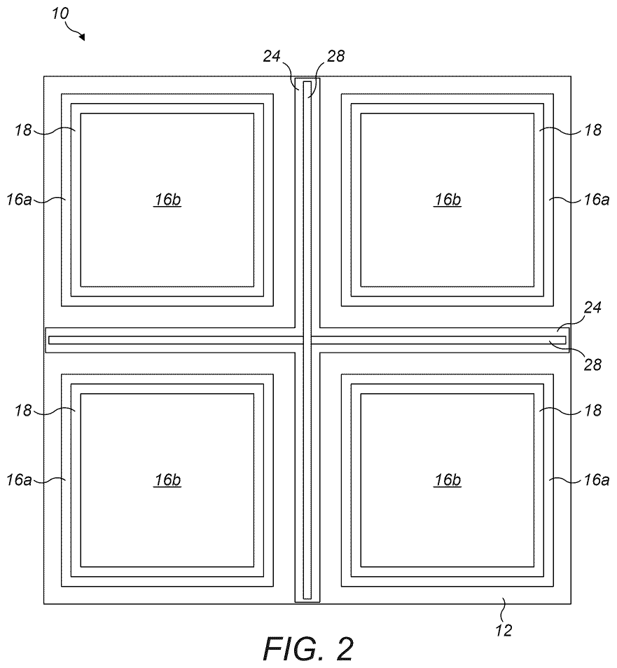

b. FIG. 2 shows the antenna of FIG. 1 in plan view; and

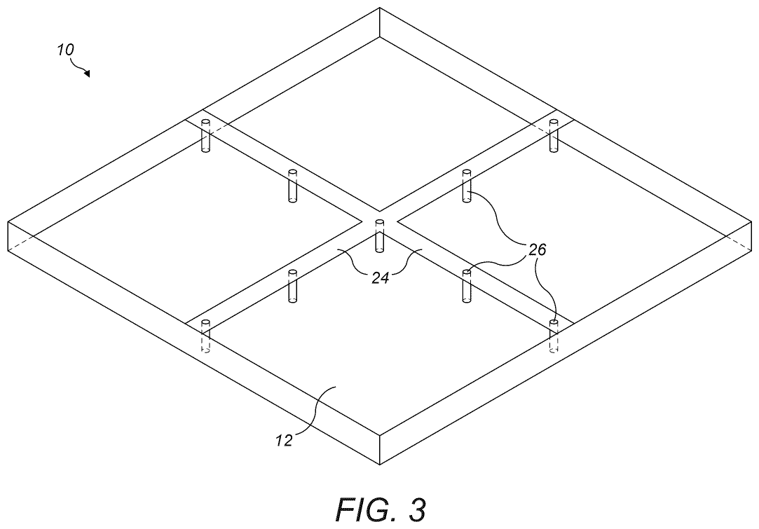

C. FIG. 3 corresponds to FIG. 1 but with some components hidden to reveal internal features of the antenna.

### DETAILED DESCRIPTION

In general terms, embodiments of the invention provide stacked patch array antennas, also referred to as antenna arrays, that provide multi-band performance. Such antennas may offer superior performance for GNSS reception, for example, compared to an antenna having a single stacked patch. In some embodiments, stacked patch array antennas are further configured to be used as anti-jam GNSS antennas, and/or as anti-jam RNSS antennas, for example, or within antenna systems that can combat other unintentional interference, or even multipath systems. Antennas according to the invention may be used in various applications, including on moving platforms such as aircraft, waterborne vessels and land vehicles, for example. In some embodiments, the antenna is compact and so is apt for use in space-constrained applications, for example in unmanned aircraft systems (UAS). The antenna may also be relatively low cost to manufacture.

FIGS. 1 to 3, which are now referred to collectively, show an example of a stacked patch array antenna 10 according to an embodiment of the invention. The antenna 10 is configured to be mounted within a cavity of a device, system or platform in which the antenna 10 is to be used, and has a degree of conformance with the cavity and surrounding surface.

In general terms, the stacked patch array antenna 10 comprises an array of individual radiators that act together as a single antenna 10, as is conventional. The stacked patch array antenna 10 is therefore referred to simply as the ‘antenna’ in the description that follows.

More specifically, the antenna 10 is configured for use as an anti-jam GNSS antenna, specifically an anti-jam GPS antenna in this example, through the configuration of the radiators and a feed arrangement and by applying suitable processing to the signals received and/or transmitted by the individual radiators to remove interference, according to known principles. The antenna 10 may be configured as a controlled reception pattern array (CRPA), for example. The anti-jam configuration of the antenna 10 is not the subject of this disclosure and so details of this are omitted for clarity.

The antenna 10 comprises a main substrate 12 that also acts as a base of the antenna 10. The main substrate 12 is a thin, rigid, flat, square board having planar surfaces, and may be similar to a substrate of a conventional PCB. The main substrate 12 is formed from a ceramic material with a controlled dielectric constant in this example. As ceramic has high dielectric permittivity, the use of this material supports miniaturisation of the antenna 10. In this respect, the size of the main substrate 12 is determined according to the number of radiators it is to accommodate and the frequencies that the antenna 10 is configured to operate at.

A lower surface of the main substrate 12, in the orientation shown in the figures, is covered by a continuous conductive layer, for example a metallic layer, which defines a main ground plane 14 for the antenna 10. In use, the main ground plane 14 may be electrically connected to a surface in which the antenna 10 is mounted, for example, to use that surface as a ground plane.

An upper surface of the main substrate 12, in the orientation shown in the figures, supports a set of patch radiators 16. In this example, the set comprises eight radiators 16 arranged in two layers laid one on top of the other, each layer being composed of four radiators 16 arranged in a two-by-two square array. In other examples, an antenna may include additional layers of radiators and/or have a different number of radiators in each layer. The radiators in each layer can also be arranged in any pattern depending on the antenna application, and not necessarily a square pattern as in this example.

Specifically, in this example a first array of radiators 16a is formed directly onto the upper surface of the main substrate 12, so that the main substrate 12 defines a common, unitary substrate for the first array of radiators 16a and for the antenna 10. The radiators 16a of the first array are substantially identical to one another in this example, and are oriented with edges parallel to edges of the main substrate 12, with respective adjacent edges of the radiators 16a also being parallel to one another. The common unitary substrate is formed as a single piece in this example, but can also be formed by individual pieces of substrate that are fixed together. Meanwhile, a second array of radiators 16b is arranged on top of the first array, the radiators 16b of the second array being substantially identical to one another in this example. Accordingly, the first array of radiators 16a is disposed between the second array of radiators 16b and the main substrate 12.

In this example, the first and second arrays operate at respective frequency bands, providing dual-band performance for the antenna 10 as a whole. The frequency band in which the radiators 16a of the first array operate is lower than that at which the radiators 16b of the second array operate. So, in this description the radiators 16a of the first array are also referred to as ‘low-frequency radiators’, and the radiators 16b of the second array are also referred to as ‘high-frequency radiators’. As an example, the radiators 16a of the first array could be tuned to handle signals in a frequency band that includes the GPS L2 frequency, while the radiators 16b of the second array could be tuned to handle signals in a frequency band that includes the GPS L1 frequency.

Each radiator 16a of the first array cooperates with the main substrate 12 to form a respective patch element, so that the first array defines four patch elements that share a common substrate. It follows that the low-frequency radiators 16a also share the main ground plane 14.

Each radiator 16b of the second array is arranged centrally on a respective low-frequency radiator 16a to form a stacked pair of radiators 16. It follows that the antenna 10 may also be regarded as comprising a two-by-two square array of stacked pairs of radiators 16, each pair having one low-frequency radiator 16a and one high-frequency radiator 16b.

Each radiator 16b of the second array is formed on a respective substrate 18, which may be referred to as a superstrate, to form a radiator element 20. Accordingly, the high-frequency radiators 16b have individual substrates 18 in this example. The substrates 18 of the radiator elements 20 are of the same material as the main substrate 12 in this example, although they could be of a different material to the main substrate 12 in other examples.

Each radiator element 20 also has a continuous conductive layer on its underside, and therefore on the opposite side of the substrate 18 to the high-frequency radiator 16b, to form a ground plane for the element 20. The ground plane may be metallic. However, in other examples the radiator elements 20 may not have conductive layers on the underside, and instead the conductive part of the low-frequency radiator 16a may act as the ‘ground’ to the associated high-frequency radiator 16b.

Each radiator 16 of the set comprises, and is substantially defined by, a layer of conductive material formed on, and covering a portion of, the associated substrate, to form a patch. The patches 16 may be of a metal such as copper, for example, and may be formed on the substrate 12, 18 using conventional techniques. The patches 16 may therefore be defined by metallised areas formed on a surface of the associated substrate. Each patch 16 is therefore very thin and so may be regarded as a flat plate element that predominantly extends in a plane parallel to the surface of the substrate 12, 18 on which it is formed. The patch radiators 16 are also electrically thin, in that they have a small thickness relative to the wavelengths that they are configured to operate at. It is possible for the patch elements to be slightly curved in other embodiments, in which case the curvature may be determined to maintain a small depth relative to the length and width of the plate. Curved elements may be used for conformance with another surface, for example.

In this embodiment, the length and width of the radiators 16 are such that the radiators 16 are substantially square, although different shapes may be used in other embodiments.

Each radiator 16 has a patch face defined by an uninterrupted, generally planar and square surface facing outwardly from the associated substrate. The respective patch faces of the radiators 16a of the first array are coplanar in a first plane. Similarly, the respective patch faces of the radiators 16b of the second array are coplanar in a second plane that is parallel to, and offset from, the first plane.

Each radiator element 20 is placed on top of a corresponding radiator 16a of the first array, so that each stacked pair of radiators 16 are aligned along a respective radiator axis 22, which axis 22 extends orthogonally to the main substrate 12 and intersects the respective centres of each radiator 16 of the pair. One of the radiator axes 22 is shown in FIG. 1 for illustrative purposes. The radiators 16 of each stacked pair are also arranged so that their respective adjacent edges extend in parallel.

The substrate 18 of each radiator element 20 may be secured to the associated low-frequency radiator 16a beneath in any suitable way. In this example, the substrate 18 of the radiator element 20 and the underlying low-frequency radiator 16a are fused together.

The substrates 18 of the radiator elements 20 are also square, and are slightly wider than the patch radiators 16b that they support. A portion of the surface of the substrate 18 therefore extends beyond the edges of the radiator, to form a border around the radiator 16b. Each high-frequency radiator 16b is centred on its respective substrate 18 and is oriented so that the edges of the radiator 16b and the substrate 18 are parallel.

The substrates 18 of the radiator elements 20 are dimensioned to be slightly narrower than the low-frequency radiators 16a. So, and as best seen in FIG. 2, while each radiator element 20 substantially covers its associated low-frequency radiator 16a, a small portion of that underlying low-frequency radiator 16a extends beyond the edges of the substrate 18 of the radiator element 20 above it, around the periphery of the substrate. Accordingly, a portion of each low-frequency radiator 16a is exposed, beneficially allowing for tuning of the low-frequency radiators 16a when the antenna 10 is assembled, in that the exposed portions of the low-frequency radiators 16a are accessible for trimming or other processing. Similarly, the high-frequency radiators 16b are entirely exposed and so are also readily accessible. Although not shown in the figures, the radiators 16 may be provided with tuning tabs to facilitate tuning. If manufacturing tolerances are tight when creating any of the substrates 12, 18, so that the dielectric constant of the substrate 12, 18 is tightly controlled, it is possible to create an antenna which does not require tuning of the metallisation.

It follows from the above that the high-frequency radiators 16b are smaller than the low-frequency radiators 16a. As the skilled reader will appreciate, the size and shape of each radiator 16 in part determines its resonant frequency and bandwidth, and so can be adjusted to suit the requirements of the system in which the antenna 10 is used.

Although not shown in the drawings, the antenna 10 also includes a feed arrangement for feeding the radiators 16. Feeding of the radiators 16 can be achieved in conventional ways, for example using direct probes or by implementing an aperture coupled arrangement. In this example, the feed arrangement comprises individual conductors, for example wires or traces, directly connected to each high-frequency radiator 16b to feed those radiators directly. Meanwhile, the radiators 16a of the first array are capacitively coupled to the high-frequency radiators 16b in this example. The conductors connecting to the high-frequency radiators 16b may be routed between the ground plane of the associated radiator element 20 and the main ground plane 14, in which case the conductors extend between two ground planes and so may form a stripline, so that the feed conductors collectively create a stripline network. The stripline network can be matched in situ by trimming the radiators 16 as may be appropriate. Each radiator 16 is fed by a pair of ports that are sequentially rotated, providing circular polarisation.

Placing an array of radiators on a common substrate, as in this example, represents a departure from convention, in that radiators would ordinarily be formed on individual substrates and in separate housings to form separate elements. The use of high permittivity ceramic substrates in this context represents a further departure from convention. Using a common substrate for the low-frequency radiators 16a beneficially enables those radiators to be positioned relative to one another with a high degree of precision. As noted above, improving the accuracy of the positioning of the radiators 16 contributes to improved performance of the antenna 10. The main substrate 12 can also be smaller than the corresponding combined area of the substrates of an equivalent antenna having separate radiator elements 20, for example as there is no need for separate housings. This enables the antenna 10 to be more compact than an equivalent antenna based on separate elements.

Using a common substrate also simplifies assembly of the array and reduces the part count, and so tends to reduce the cost of fabricating the antenna 10. The use of a ceramic substrate may also enable the antenna to withstand higher temperatures than an equivalent antenna having separate radiator elements 20.

However, arranging multiple radiators on a common substrate in close proximity, depending on the configuration of the antenna, may create a threat of surface waves forming on the substrate that produce strong energy mutual coupling between the radiators. This risk may be elevated if the substrate is of a ceramic material as in this example. The radiators may also interact by radiative coupling. In turn, coupling between the radiators may degrade the performance of the antenna, by reducing the radiated power and the signal-to-noise ratio, as well as diminishing the radiation pattern of the antenna.

The antenna 10 of this example implements measures to mitigate these problems, or otherwise enhance performance of the antenna 10, while using a common substrate to exploit the associated advantages. More specifically, in this example the antenna 10 includes a shielding arrangement that acts to resist interaction between the radiators 16 and/or the effect of surface waves, as shall become clear from the following description.

Referring to FIG. 3, in which the radiators 16 are hidden, the upper surface of the main substrate 12 also includes a pair of thin conductive tracks 24 extending from one side of the main substrate 12 to the other. The tracks 24 are orthogonal to one another and parallel to respective edges of the main substrate 12. The tracks 24 extend centrally across the main substrate 12, between the low-frequency radiators 16a, to intersect at the centre of the substrate 12. In this example, the tracks 24 are continuous with one another and so could instead be regarded as a single track having an ‘X’ shape. Each track 24 has parallel edges, a distance between which defines a width of the track 24, which is sufficiently narrow to provide a gap between each track and the adjacent low frequency radiators 16a, so that the tracks 24 are not directly electrically connected to the radiators 16a. The tracks 24 may be formed from the same material as the radiators 16, optionally using similar processes. The tracks 24 may be formed as printed metallic traces, for example.

A set of plated through holes defining vias 26 penetrate the main substrate 12, to act as electrical links that provide interconnections between the tracks 24 and the main ground plane 14. In this example, the set of vias 26 includes one via 26 at the centre of the main substrate 12 where the tracks 24 intersect, a via 26 at each end of each track 24, and further vias 26 placed midway between the central via 26 and the vias 26 at each end of each track 24, giving nine vias 26 in total. The vias 26 are therefore arranged in orthogonal rows in this example, and are regularly spaced within those rows. The placement and number of vias 26 may vary in other examples. The vias 26 may be plated with a similar material to the tracks 24 and the main ground plane 14, providing continuity of the conductive material between the tracks 24 and the main ground plane 14.

Returning now to FIG. 1, planar plate elements defining barriers or ribs 28 extend upwardly from each of the tracks 24 on the surface of the main substrate 12, to occupy spaces between neighbouring radiators 16 of the first and second arrays. Each rib 28 is orthogonal to the surface of the main substrate 12 and is significantly taller with respect to the main substrate 12 than it is deep, extending some way above the high-frequency radiators 16b. The depth of each rib 28 is slightly smaller than the width of the track on which the rib 28 is placed, so that the rib 28 is fully received on the track 24. The length of each rib 28 corresponds to the width of the main substrate 12. Like the tracks 24, the ribs 28 are orthogonal to one another and parallel to respective edges of the main substrate 12, and intersect one another at the centre of the main substrate 12.

The ribs 28 may be formed from a metallic material, radiation absorption material (RAM), or a mixture of materials, for example metal-backed RAM. The ribs 28 are attached to the main substrate 12 in a manner that provides an electrical connection between the rib 28 and the underlying track 24, for example using a conductive adhesive such as solder or conductive epoxy. High temperature epoxy adhesive may be used to support operation of the antenna 10 at high temperatures. The ribs 28 are therefore electrically connected, through the vias 26, to the main ground plane 14. The ribs 28, tracks 24, vias 26 and the main ground plane 14 are therefore electrically continuous.

Each rib 28 is configured to act as a physical barrier or shield that resists surface waves and radiative coupling between the radiators 16 on each side of the rib, and particularly between the high-frequency radiators 16b. The grounded vias 26, meanwhile, disrupt the propagation of surface waves in the main substrate 12 by short-circuiting the waves. Consequently, this mitigates the ability of surface waves from one high-frequency radiator 16a to reach adjacent high-frequency radiators 16a via this mechanism.

The ribs 28 and the vias 26 therefore collectively act to mitigate the problems that may otherwise arise from using a common substrate for an array of radiators, in particular to minimise coupling or other interaction between the radiators and to reduce the effect of surface wave excitations. In this way, the ribs 28 and the vias 26 collectively define the shielding arrangement that acts to resist interaction between the radiators 16 and/or the effect of surface wave excitations in this example. This enables the antenna 10 to provide excellent dual-band performance within a compact space envelope. By way of non-limiting example, the mutual coupling between elements can be reduced by 10 dB or more. In other examples, a shielding arrangement may be provided in other ways, and may not include ribs and/or vias. It is also possible for a shielding arrangement to be omitted in some configurations.

It will be appreciated that various changes and modifications can be made to the present invention without departing from the scope of the present application.

For example, an array of two or more elements can be used to produce an antenna array such as an anti-jam GNSS antenna array; these radiators do not have to be arranged in a two-by-two square, and pattern arrangements may vary depending on the end application.

The common substrate does not have to be square as in the above example. For example, it can have chamfered edges, or be a different shape entirely, to suit the requirements of each application.

The number and placement of radiators may vary, and suitably shaped ribs may be provided to create similar isolation to that of the above example for different radiator arrangements. Also, radiators within the first array are not necessarily the same as each other as in the above example, but may be of different sizes and/or shapes to one another. Similarly, radiators within the second array may be of different sizes and/or shapes to one another.

In some embodiments, the main substrate may include grooves or recesses to receive the ribs, potentially enabling the ribs to be directly connected to the main ground plane without the need of the vias of the above example. For example, the base of a recess may include one or more openings enabling a rib received in the recess to connect directly to the main ground plane.

As noted above, the ribs may be formed from a variety of materials and may, for example, be covered with a thin layer of RAM. The ribs may also have alternative shapes, and may have serrated top edges for example. Similarly, the ribs may not be flat and straight members as in the above example, but may be shaped with one or more bends in a plane parallel to the upper surface of the main substrate. For example, the ribs could have a wavy or corrugated profile. Shaping the ribs in this way may enable a more stable radiation pattern in some configurations, and may also enable the ribs to contribute to tuning of individual radiators of the array. It is also possible for the ribs to be omitted altogether in some embodiments. Likewise, the vias of the above example may be omitted in some embodiments.

In some embodiments, an antenna is configured for use in RNSS systems instead of, or in addition to, GNSS systems. More generally, stacked patch array antennas according to the invention may be configured for a range of applications, and not necessarily for anti-jam GNSS applications.

1. A stacked patch array antenna, comprising:
a first substrate;
a first array of patch radiators arranged on the first substrate; and
a second array of patch radiators, each radiator of the second array being stacked with a respective radiator of the first array, so that each radiator of the first array is disposed between the first substrate and a respective radiator of the second array.

2. The antenna of claim 1, wherein the radiators of the first array are configured for a first frequency band.

3. The antenna of claim 2, wherein the first frequency band corresponds to a first GNSS frequency or RNSS frequency.

4. The antenna of claim 1, wherein the radiators of the second array are configured for a second frequency band.

5. The antenna of claim 4, wherein the radiators of the first array are configured for a first frequency band, and wherein the second frequency band is higher than the first frequency band.

6. The antenna of claim 4, wherein the second frequency band corresponds to a second GNSS frequency or RNSS frequency.

7. The antenna of claim 1, comprising a first ground plane on an opposite side of the first substrate to the first array of radiators.

8. The antenna of claim 1, wherein each radiator of the second array is on a respective second substrate to form a radiator element.

9. The antenna of claim 8, wherein the radiator elements are mutually spaced.

10. The antenna of claim 8, wherein each radiator element comprises a respective second ground plane on an opposite side of the second substrate to the respective radiator.

11. The antenna of claim 8, wherein each radiator element is attached to a respective radiator of the first array.

12. The antenna of claim 1, wherein each radiator of the second array covers a portion of the corresponding radiator of the first array, and wherein a remaining portion of the radiator of the first array is exposed.

13. The antenna of claim 1, wherein each stacked pair of radiators of the first and second arrays are centred on a common axis that is orthogonal to a surface of the first substrate.

14. The antenna of claim 1, comprising at least one barrier extending between adjacent radiators of the first array.

15. The antenna of claim 14, wherein the barrier also extends between adjacent radiators of the second array.

16. The antenna of claim 14, wherein the barrier is configured to resist interaction between the adjacent radiators.

17. The antenna of claim 14, wherein the barrier is mounted to the first substrate.

18. The antenna of claim 14, comprising a first ground plane on an opposite side of the first substrate to the first array of radiators, wherein the barrier is electrically connected to the first ground plane.

19. The antenna of claim 14, comprising a barrier extending between each adjacent pair of radiators of each of the first and second arrays.

20. The antenna of claim 14, comprising a pair of barriers that are orthogonal to one another.

21. The antenna of claim 20, wherein the barriers intersect at a centre of the first substrate.

22. The antenna of claim 14, wherein the barrier comprises a plate element.

23. The antenna of claim 14, wherein the barrier has the form of a rib or a fin.

24. The antenna of claim 14, wherein the barrier is flat and/or straight.

25. The antenna of claim 1, comprising at least one electrical link extending through the first substrate.

26. The antenna of claim 25, wherein the or each link extends from a surface of the first substrate on which the radiators of the first array are arranged to an opposite side of the first substrate.

27. The antenna of claim 25, wherein the or each link is disposed between adjacent radiators of the first array.

28. The antenna of claim 27, comprising at least one row of links extending between adjacent radiators of the first array.

29. The antenna of claim 25, comprising a conductor arranged on a side of the first substrate on which the radiators of the first array are arranged, wherein the conductor connects links together electrically.

30. The antenna of claim 25, comprising a first ground plane on an opposite side of the first substrate to the first array of radiators, wherein the or each link is electrically connected to the first ground plane.

31. The antenna of claim 25, comprising at least one barrier extending between adjacent radiators of the first array, wherein the barrier is electrically connected to at least one link.

32. The antenna of claim 25, wherein the or each electrical link comprises a via.

33. The antenna of claim 1, comprising a shielding arrangement configured to resist interaction between the radiators.

34. The antenna of claim 33, wherein the shielding arrangement comprises at least one barrier extending between adjacent radiators of the first array.

35. The antenna of claim 33, wherein the shielding arrangement comprises at least one electrical link extending through the first substrate.

36. The antenna of claim 1, wherein the first substrate is of ceramic material.

37. The antenna of claim 1, comprising a feed arrangement configured to feed the first and second arrays of radiators.

38. The antenna of claim 37, wherein the feed arrangement is configured to feed the radiators of the second array directly.

39. The antenna of claim 38, wherein the radiators of the first array are fed by capacitive coupling.

40. The antenna of claim 37, wherein the feed arrangement comprises a stripline arrangement.

41. The antenna of claim 1, wherein the radiators of the first array comprise respective coplanar surfaces.

42. The antenna of claim 1, wherein the radiators of the first array extend in a first plane, and the radiators of the second array extend in a second plane that is parallel to the first plane.

43. The antenna of claim 1, wherein at least one of the radiators is substantially square.

44. The antenna of claim 1, configured as an anti-jam antenna.

45. The antenna of claim 1, configured for communication with a satellite system.

46. The antenna of claim 45, configured as a GNSS antenna and/or an RNSS antenna.

47. The antenna of claim 1, wherein the radiators of the first array are in direct contact with the first substrate.

48. A communication system comprising the antenna of claim 1.

49. A method of producing a stacked patch array antenna, the method comprising:
arranging a first array of patch radiators on a first substrate; and
arranging a second array of patch radiators so that each radiator of the second array is stacked with a respective radiator of the first array, and each radiator of the first array is disposed between the first substrate and a respective radiator of the second array.
